(19) United States
(12) Patent Application Publication
(10) Pub. No.: US 2016/0119969 A1
(43) Pub. Date: Apr. 28, 2016

(54) MAC ENHANCEMENTS FOR CONCURRENT LEGACY AND ECC OPERATION

(71) Applicant: QUALCOMM Incorporated, San Diego, CA (US)

(72) Inventors: Madhavan Srinivasan Vajapeyam, San Diego, CA (US); Jelena Damnjanovic, Del Mar, CA (US); Aleksandar Damnjanovic, Del Mar, CA (US)

(21) Appl. No.: 14/866,010

(22) Filed: Sep. 25, 2015

Related U.S. Application Data
(60) Provisional application No. 62/068,355, filed on Oct. 24, 2014.

(51) Int. Cl. H04W 76/04; H04W 72/14; H04W 24/10; H04W 72/12

(52) U.S. Cl. CPC H04W 76/048; H04W 72/1289; H04W 72/14; H04W 24/10

(57) ABSTRACT

Updated media access control (MAC) operations for semi-persistent scheduling (SPS) and discontinuous reception (DRX) operations with enhanced component carrier (eCC) secondary cells (SCells) is disclosed. For SPS operations, an SPS operation is defined and monitored on the eCC SCell which is separate and independent from SPS operations on the primary cell (PCell). The eCC SCell SPS operation may be identified using either the network identifier for the PCell or a newly defined network identifier specifically for the eCC SCell SPS operation. For DRX operations, the DRX operations for the eCC SCell are defined with separate and independent timers from the DRX operations of the PCell.

### CROSS-REFERENCE TO RELATED APPLICATIONS

This application claims the benefit of U.S. Provisional Patent Application No. 62/068,355, entitled, “MAC ENHANCEMENTS FOR ECC OPERATION IN LTE,” filed on Oct. 24, 2014, which is expressly incorporated by reference herein in its entirety.

### BACKGROUND

1. Field

Aspects of the present disclosure relate generally to wireless communication systems, and more particularly, to media access control (MAC) enhancements for concurrent legacy and enhanced component carrier (eCC) operation.

2. Background

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). Examples of multiple-access network formats include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance the UMTS technologies not only to meet the growing demand for mobile broadband access, but to advance and enhance the user experience with mobile communications.

### SUMMARY

In one aspect of the disclosure, a method of wireless communication includes receiving, at a user equipment (UE) from a base station, configuration of a primary semi-persistent scheduling (SPS) network identifier for a primary SPS operation on a primary cell (PCell) configured for the UE, receiving, at the UE from the base station, configuration of a secondary SPS network identifier for a second SPS operation on an enhanced component carrier (eCC) secondary cell (SCell) configured for the UE, wherein the secondary SPS operation is independent of the primary SPS operation, monitoring, by the UE, for one or more primary SPS grants associated with the primary SPS operation using the primary SPS network identifier, and monitoring, by the UE, for one or more secondary SPS grants associated with the secondary SPS operation using the secondary SPS network identifier.

In an additional aspect of the disclosure, a method of wireless communication includes entering, by a UE, a primary sleep period of a primary discontinuous reception (DRX) cycle associated with a PCell configured for the UE, wherein the primary sleep period triggers the UE to stop monitoring the PCell, and entering, by the UE, a secondary sleep period of a secondary DRX cycle associated with an eCC PCell configured for the UE, where the secondary sleep period triggers the UE to stop monitoring the eCC SCell, the secondary DRX cycle is independent from the primary DRX cycle, and the secondary sleep period is of a different duration than the primary sleep period, such as a shorter duration than the primary sleep period. The method further includes actively monitoring, by the UE, a downlink control channel on the PCell after the primary sleep period and on the eCC SCell after the secondary sleep period.

In an additional aspect of the disclosure, an apparatus configured for wireless communication includes means for receiving, at a UE from a base station, configuration of a primary SPS network identifier for a primary SPS operation on a PCell configured for the UE, means for receiving, at the UE from the base station, configuration of a secondary SPS network identifier for a second SPS operation on an eCC SCell configured for the UE, wherein the secondary SPS operation is independent of the primary SPS operation, means for monitoring, by the UE, for one or more primary SPS grants associated with the primary SPS operation using the primary SPS network identifier, and means for monitoring, by the UE, for one or more secondary SPS grants associated with the secondary SPS operation using the secondary SPS network identifier.

In an additional aspect of the disclosure, an apparatus configured for wireless communication includes means for entering, by a UE, a primary sleep period of a primary DRX cycle associated with a PCell configured for the UE, wherein the primary sleep period triggers the UE to stop monitoring the PCell, and means for entering, by the UE, a secondary sleep period of a secondary DRX cycle associated with an eCC PCell configured for the UE, where the secondary sleep period triggers the UE to stop monitoring the eCC SCell, the secondary DRX cycle is independent from the primary DRX cycle, and the secondary sleep period is of a different duration than the primary sleep period, such as a shorter duration than the primary sleep period. The apparatus further includes means for actively monitoring, by the UE, a downlink control channel on the PCell after the primary sleep period and on the eCC SCell after the secondary sleep period.

In an additional aspect of the disclosure, a computer-readable medium having program code recorded thereon. This program code includes code to receive, at a UE from a base station, configuration of a primary SPS network identifier for a primary SPS operation on a PCell configured for the UE, code to receive, at the UE from the base station, configuration of a secondary SPS network identifier for a second SPS operation on an eCC SCell configured for the UE, wherein the secondary SPS operation is independent of the primary SPS operation, code to monitor, by the UE, for one or more primary SPS grants associated with the primary SPS operation using the primary SPS network identifier, and code to monitor, by the UE, for one or more secondary SPS grants associated with the secondary SPS operation using the secondary SPS network identifier.

In an additional aspect of the disclosure, a computer-readable medium having program code recorded thereon. This program code includes code to enter, by a UE, a primary sleep period of a primary DRX cycle associated with a PCell configured for the UE, wherein the primary sleep period triggers the UE to stop monitoring the PCell, and code to enter, by the UE, a secondary sleep period of a secondary DRX cycle associated with an eCC PCell configured for the UE, where the secondary sleep period triggers the UE to stop monitoring the eCC SCell, the secondary DRX cycle is independent from the primary DRX cycle, and the secondary sleep period is of a different duration than the primary sleep period, such as a shorter duration than the primary sleep period. The program code further includes code to actively monitor, by the UE, a downlink control channel on the PCell after the primary sleep period and on the eCC SCell after the secondary sleep period.

In an additional aspect of the disclosure, an apparatus includes at least one processor and a memory coupled to the processor. The processor is configured to receive, at a UE from a base station, configuration of a primary SPS network identifier for a primary SPS operation on a PCell configured for the UE, to receive, at the UE from the base station, configuration of a secondary SPS network identifier for a second SPS operation on an eCC SCell configured for the UE, wherein the secondary SPS operation is independent of the primary SPS operation, to monitor, by the UE, for one or more primary SPS grants associated with the primary SPS operation using the primary SPS network identifier, and to monitor, by the UE, for one or more secondary SPS grants associated with the secondary SPS operation using the secondary SPS network identifier.

In an additional aspect of the disclosure, an apparatus includes at least one processor and a memory coupled to the processor. The processor is configured to enter, by a UE, a primary sleep period of a primary DRX cycle associated with a PCell configured for the UE, wherein the primary sleep period triggers the UE to stop monitoring the PCell, and to enter, by the UE, a secondary sleep period of a secondary DRX cycle associated with an eCC PCell configured for the UE, where the secondary sleep period triggers the UE to stop monitoring the eCC SCell, the secondary DRX cycle is independent from the primary DRX cycle, and the secondary sleep period is of a different duration than the primary sleep period, such as a shorter duration than the primary sleep period. The processor is further configured to actively monitor, by the UE, a downlink control channel on the PCell after the primary sleep period and on the eCC SCell after the secondary sleep period.

In an additional aspect of the disclosure, a method of wireless communication includes entering, by a UE, a primary sleep period of a primary discontinuous reception (DRX) cycle associated with a PCell configured for the UE, wherein the primary sleep period triggers the UE to stop monitoring the PCell, and entering, by the UE, a secondary sleep period of a secondary DRX cycle associated with an eCC PCell configured for the UE, where the secondary sleep period triggers the UE to stop monitoring the eCC SCell, the secondary DRX cycle is independent from the primary DRX cycle, and the secondary sleep period is of a different duration than the primary sleep period, such as a shorter duration than the primary sleep period. The method further includes actively monitoring, by the UE, a downlink control channel on the PCell after the primary sleep period and on the eCC SCell after the secondary sleep period, receiving, by the UE, a control element on the downlink control channel of the eCC SCell for operations on the PCell, and performing operations, by the UE, associated with one or more of: the PCell and one or more SCells based on the control element received on the downlink control channel of the eCC SCell.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description, and not as a definition of the limits of the claims.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram conceptually illustrating an example of a mobile communication system.

FIG. 2 shows a diagram that illustrates an example of carrier aggregation when using LTE concurrently in licensed and unlicensed spectrum according to various embodiments.

FIG. 3 is a block diagram conceptually illustrating a design of a base station/eNB and a UE configured according to one aspect of the present disclosure.

FIG. 4 is a block diagram illustrating an enhanced component carrier (eCC) transmission stream.

FIG. 5 is a block diagram illustrating a communication network configured according to one aspect of the present disclosure.

FIG. 6 is a block diagram illustrating the transmission stream between an eCC secondary cell (SCell) and a UE configured according to one aspect of the present disclosure.

FIG. 7 is a block diagram illustrating example blocks executed to implement one aspect of the present disclosure.

FIG. 8 is a block diagram illustrating a primary cell (PCell) and an eCC SCell configured according to one aspect of the present disclosure.

FIG. 9 is a block diagram illustrating example blocks executed to implement one aspect of the present disclosure.

FIG. 10 is a block diagram illustrating a UE configured according to aspects of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

Operators have so far looked at WiFi as the primary mechanism to use unlicensed spectrum to relieve ever increasing levels of congestion in cellular networks. However, a new carrier type (NCT) based on LTE/LTE-A including an unlicensed spectrum may be compatible with carrier-grade WiFi, making LTE/LTE-A with unlicensed spectrum an alternative to WiFi. LTE/LTE-A with unlicensed spectrum may leverage LTE concepts and may introduce some modifications to physical layer (PHY) and media access control (MAC) aspects of the network or network devices to provide efficient operation in the unlicensed spectrum and to meet regulatory requirements. The unlicensed spectrum may range from 600 Megahertz (MHz) to 6 Gigahertz (GHz), for example. In some scenarios, LTE/LTE-A with unlicensed spectrum may perform significantly better than WiFi. For example, an all LTE/LTE-A with unlicensed spectrum deployment (for single or multiple operators) compared to an all WiFi deployment, or when there are dense small cell deployments, LTE/LTE-A with unlicensed spectrum may perform significantly better than WiFi. LTE/LTE-A with unlicensed spectrum may perform better than WiFi in other scenarios such as when LTE/LTE-A with unlicensed spectrum is mixed with WiFi (for single or multiple operators).

For a single service provider (SP), an LTE/LTE-A network with unlicensed spectrum may be configured to be synchronous with a LTE network on the licensed spectrum. However, LTE/LTE-A networks with unlicensed spectrum deployed on a given channel by multiple SPs may be configured to be synchronous across the multiple SPs. One approach to incorporate both the above features may involve using a constant timing offset between LTE/LTE-A networks without unlicensed spectrum and LTE/LTE-A networks with unlicensed spectrum for a given SP. An LTE/LTE-A network with unlicensed spectrum may provide unicast and/or multicast services according to the needs of the SP. Moreover, an LTE/LTE-A network with unlicensed spectrum may operate in a bootstrapped mode (also known as licensed-assisted access (LAA) mode) in which LTE cells act as anchor and provide relevant cell information (e.g., radio frame timing, common channel configuration, system frame number or SFN, etc.) for LTE/LTE-A cells with unlicensed spectrum. In this mode, there may be close interworking between LTE/LTE-A without unlicensed spectrum and LTE/LTE-A with unlicensed spectrum. For example, the bootstrapped mode may support the supplemental downlink and the carrier aggregation modes described above. The PHY-MAC layers of the LTE/LTE-A network with unlicensed spectrum may operate in a standalone mode in which the LTE/LTE-A network with unlicensed spectrum operates independently from an LTE network without unlicensed spectrum. In this case, there may be a loose interworking between LTE without unlicensed spectrum and LTE/LTE-A with unlicensed spectrum based on RLC-level aggregation with co-located LTE/LTE-A with/without unlicensed spectrum cells, or multiflow across multiple cells and/or base stations, for example.

The techniques described herein are not limited to LTE, and may also be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). LTE and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description below, however, describes an LTE system for purposes of example, and LTE terminology is used in much of the description below, although the techniques are applicable beyond LTE applications.

Thus, the following description provides examples, and is not limiting of the scope, applicability, or configuration set forth in the claims. Changes may be made in the function and arrangement of elements discussed without departing from the spirit and scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

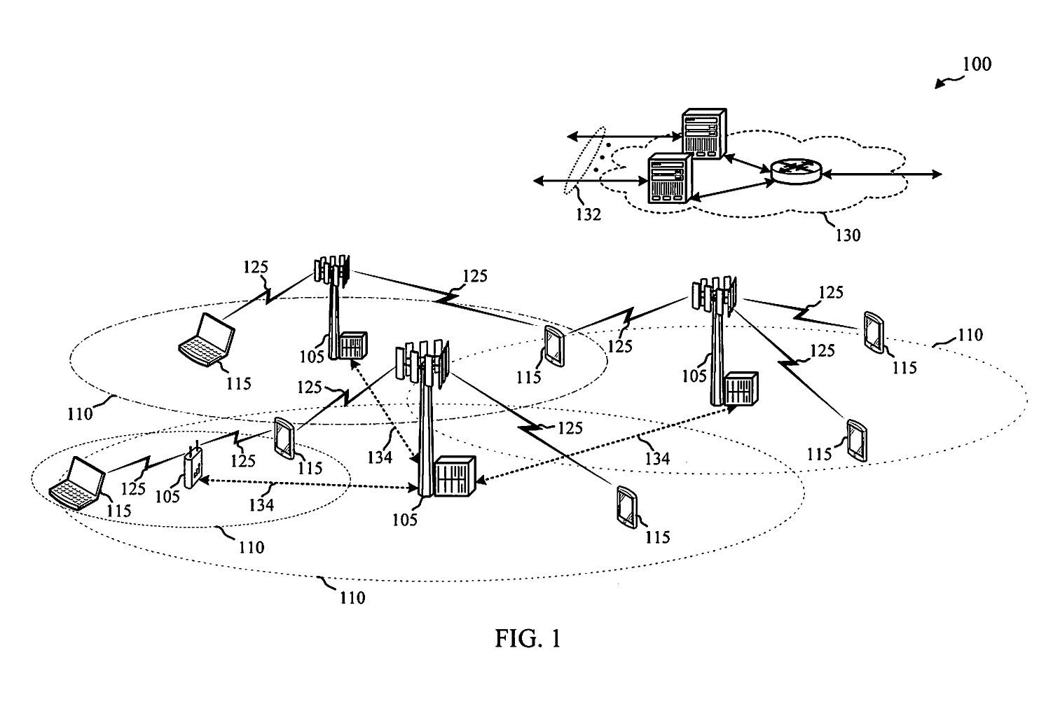

FIG. 1 illustrates an example of a wireless communications system 100 in accordance with various aspects of the disclosure. The wireless communications system 100 includes base stations 105, UEs 115, and a core network 130. The core network 130 may provide user authentication, access authorization, tracking, Internet Protocol (IP) connectivity, and other access, routing, or mobility functions. The base stations 105 interface with the core network 130 through backhaul links 132 (e.g., S1, etc.) and may perform radio configuration and scheduling for communication with the UEs 115, or may operate under the control of a base station controller (not shown). In various examples, the base stations 105 may communicate, either directly or indirectly (e.g., through core network 130), with each other over backhaul links 134 (e.g., X1, etc.), which may be wired or wireless communication links.

The base stations 105 may wirelessly communicate with the UEs 115 via one or more base station antennas. Each of the base station 105 sites may provide communication coverage for a respective geographic coverage area 110. In some examples, base stations 105 may be referred to as a base transceiver station, a radio base station, an access point, a radio transceiver, a NodeB, eNodeB (eNB), Home NodeB, a Home eNodeB, or some other suitable terminology. The geographic coverage area 110 for a base station 105 may be divided into sectors making up only a portion of the coverage area (not shown). The wireless communications system 100 may include base stations 105 of different types (e.g., macro and/or small cell base stations). There may be overlapping geographic coverage areas 110 for different technologies.

In some examples, the wireless communications system 100 is an LTE/LTE-A network. In LTE/LTE-A networks, the term evolved Node B (eNB) may be generally used to describe the base stations 105, while the term UE may be generally used to describe the UEs 115. The wireless communications system 100 may be a Heterogeneous LTE/LTE-A network in which different types of eNBs provide coverage for various geographical regions. For example, each eNB or base station 105 may provide communication coverage for a macro cell, a small cell, and/or other types of cell. The term “cell” is a 3GPP term that can be used to describe a base station, a carrier or component carrier associated with a base station, or a coverage area (e.g., sector, etc.) of a carrier or base station, depending on context.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell may cover a relatively smaller geographic area and may allow unrestricted access by UEs with service subscriptions with the network provider. A femto cell also may cover a relatively small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB or a home eNB. An eNB may support one or multiple (e.g., two, three, four, and the like) cells (e.g., component carriers).

The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The communication networks that may accommodate some of the various disclosed examples may be packet-based networks that operate according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use Hybrid ARQ (HARQ) to provide retransmission at the MAC layer to improve link efficiency. In the control plane, the Radio Resource Control (RRC) protocol layer may provide establishment, configuration, and maintenance of an RRC connection between a UE 115 and the base stations 105 or core network 130 supporting radio bearers for the user plane data. At the Physical (PHY) layer, the transport channels may be mapped to Physical channels.

The UEs 115 are dispersed throughout the wireless communications system 100, and each UE 115 may be stationary or mobile. A UE 115 may also include or be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with various types of base stations and network equipment including macro eNBs, small cell eNBs, relay base stations, and the like.

The communication links 125 shown in wireless communications system 100 may include uplink (UL) transmissions from a UE 115 to a base station 105, and/or downlink (DL) transmissions, from a base station 105 to a UE 115. The downlink transmissions may also be called forward link transmissions while the uplink transmissions may also be called reverse link transmissions. Each communication link 125 may include one or more carriers, where each carrier may be a signal made up of multiple sub-carriers (e.g., waveform signals of different frequencies) modulated according to the various radio technologies described above. Each modulated signal may be sent on a different sub-carrier and may carry control information (e.g., reference signals, control channels, etc.), overhead information, user data, etc. The communication links 125 may transmit bidirectional communications using FDD (e.g., using paired spectrum resources) or TDD operation (e.g., using unpaired spectrum resources). Frame structures for FDD (e.g., frame structure type 1) and TDD (e.g., frame structure type 2) may be defined.

In some embodiments of the system 100, base stations 105 and/or UEs 115 may include multiple antennas for employing antenna diversity schemes to improve communication quality and reliability between base stations 105 and UEs 115. Additionally or alternatively, base stations 105 and/or UEs 115 may employ multiple-input, multiple-output (MIMO) techniques that may take advantage of multi-path environments to transmit multiple spatial layers carrying the same or different coded data.

Wireless communications system 100 may support operation on multiple cells or carriers, a feature which may be referred to as carrier aggregation (CA) or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both FDD and TDD component carriers.

As described above, the typical service provider that may benefit from the capacity offload offered by using LTE/LTE-A with unlicensed spectrum is a traditional mobile network operator (MNO) with LTE spectrum. An MNO is a provider of wireless communication services that owns or controls all the elements necessary to sell and deliver services to an end user. For these service providers, an operational configuration may include a bootstrapped mode (e.g., supplemental downlink, carrier aggregation) that uses the LTE primary component carrier (“PCC” or “PCell”) on the licensed spectrum and the LTE secondary component carrier (“SCC” or “SCell”) on the unlicensed spectrum.

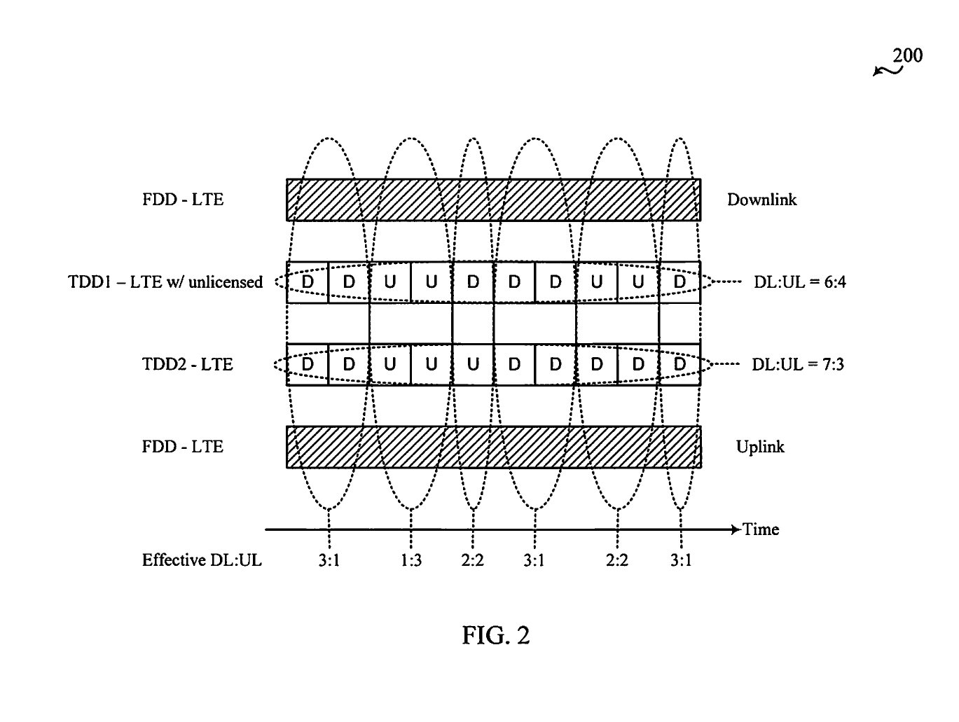

Turning next to FIG. 2, a diagram 200 illustrates an example of carrier aggregation when using LTE concurrently in licensed and unlicensed spectrum according to various embodiments. The carrier aggregation scheme in diagram 200 may correspond to the hybrid FDD-TDD carrier aggregation. This type of carrier aggregation may be used in at least portions of the system 100 of FIG. 1. Moreover, this type of carrier aggregation may be used in the base stations 105 of FIG. 1, respectively, and/or in the UEs 115 of FIG. 1.

In this example, an FDD (FDD-LTE) may be performed in connection with LTE in the downlink, a first TDD (TDD1) may be performed in connection with LTE/LTE-A with unlicensed spectrum, a second TDD (TDD2) may be performed in connection with LTE with licensed spectrum, and another FDD (FDD-LTE) may be performed in connection with LTE in the uplink with licensed spectrum. TDD1 results in a DL:UL ratio of 6:4, while the ratio for TDD2 is 7:3. On the time scale, the different effective DL:UL ratios are 3:1, 1:3, 2:2, 3:1, 2:2, and 3:1. This example is presented for illustrative purposes and there may be other carrier aggregation schemes that combine the operations of LTE/LTE-A with or without unlicensed spectrum.

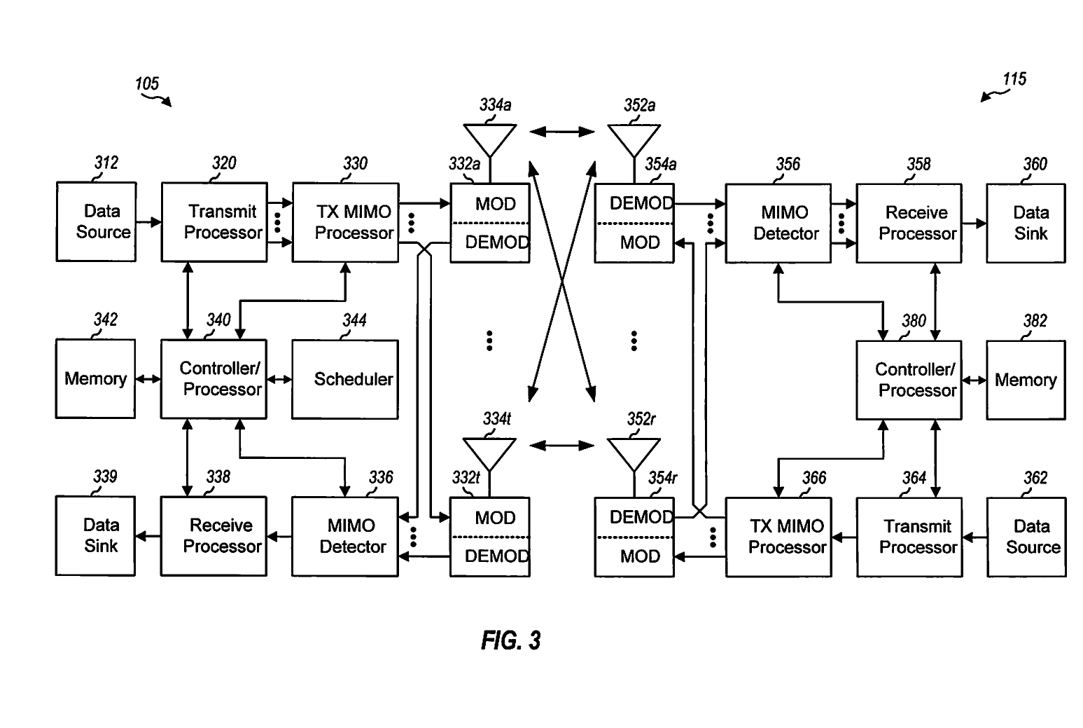

FIG. 3 shows a block diagram of a design of a base station/eNB 105 and a UE 115, which may be one of the base stations/eNBs and one of the UEs in FIG. 1. The eNB 105 may be equipped with antennas 334a through 334t, and the UE 115 may be equipped with antennas 352a through 352r. At the eNB 105, a transmit processor 320 may receive data from a data source 312 and control information from a controller/processor 340. The control information may be for the physical broadcast channel (PBCH), physical control format indicator channel (PCFICH), physical hybrid automatic repeat request indicator channel (PHICH), physical downlink control channel (PDCCH), etc. The data may be for the physical downlink shared channel (PDSCH), etc. The transmit processor 320 may process (e.g., encode and symbol map) the data and control information to obtain data symbols and control symbols, respectively. The transmit processor 320 may also generate reference symbols, e.g., for the primary synchronization signal (PSS), secondary synchronization signal (SSS), and cell-specific reference signal. A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator 332 may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 115, the antennas 352a through 352r may receive the downlink signals from the eNB 105 and may provide received signals to the demodulators (DEMODs) 354a through 354r, respectively. Each demodulator 354 may condition (e.g., filter, amplify, downconvert, and digitize) a respective received signal to obtain input samples. Each demodulator 354 may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 115 to a data sink 360, and provide decoded control information to a controller/processor 380.

On the uplink, at the UE 115, a transmit processor 364 may receive and process data (e.g., for the physical uplink shared channel (PUSCH)) from a data source 362 and control information (e.g., for the physical uplink control channel (PUCCH)) from the controller/processor 380. The transmit processor 364 may also generate reference symbols for a reference signal. The symbols from the transmit processor 364 may be precoded by a TX MIMO processor 366 if applicable, further processed by the demodulators 354a through 354r (e.g., for SC-FDM, etc.), and transmitted to the eNB 105. At the eNB 105, the uplink signals from the UE 115 may be received by the antennas 334, processed by the modulators 332, detected by a MIMO detector 336 if applicable, and further processed by a receive processor 338 to obtain decoded data and control information sent by the UE 115. The processor 338 may provide the decoded data to a data sink 339 and the decoded control information to the controller/processor 340.

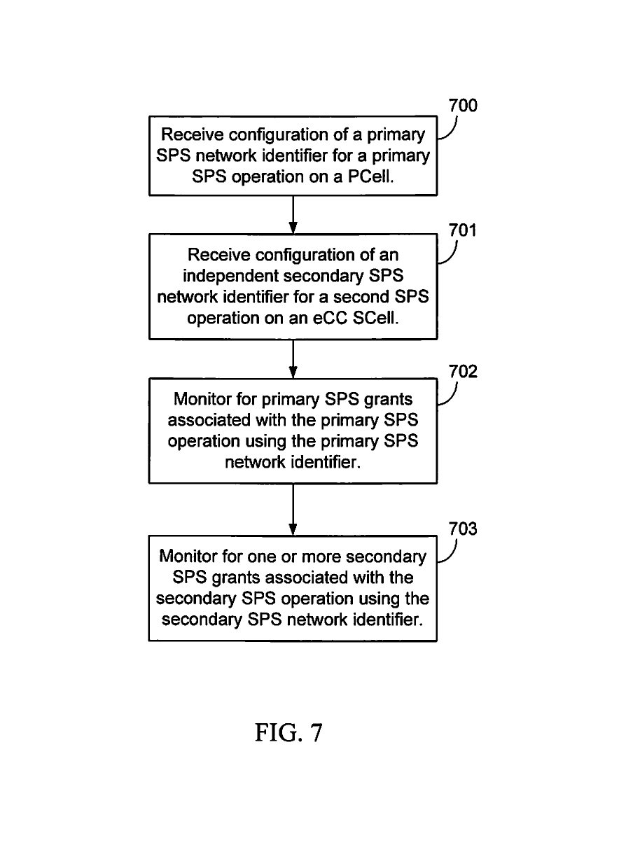

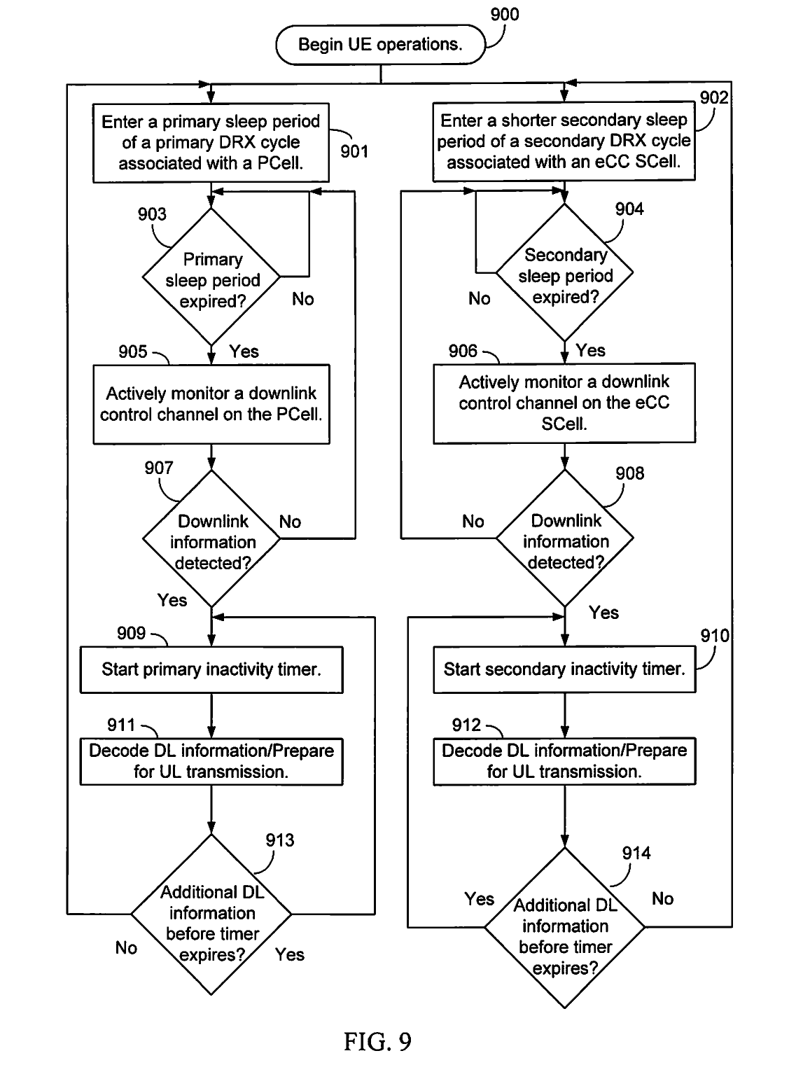

The controllers/processors 340 and 380 may direct the operation at the eNB 105 and the UE 115, respectively. The controller/processor 340 and/or other processors and modules at the eNB 105 may perform or direct the execution of various processes for the techniques described herein. The controllers/processor 380 and/or other processors and modules at the UE 115 may also perform or direct the execution of the functional blocks illustrated in FIGS. 7 and 9, and/or other processes for the techniques described herein. The memories 342 and 382 may store data and program codes for the eNB 105 and the UE 115, respectively. A scheduler 344 may schedule UEs for data transmission on the downlink and/or uplink.

With advancing technologies and access for various radio access networks using both licensed and unlicensed spectrum, it may be advantageous to provide enhancements to existing carrier configurations in order to achieve lower latency and more flexibility in bandwidth. An enhanced component carrier (eCC) is defined for use in secondary cell (SCell) or secondary component carrier (SCC) implementations. Use of such eCC may be provided for radio resource control (RRC) connected UEs, such that eCCs operations may be used in data transmissions, but not for UEs to camp on. The numerology defined for eCCs may support shorter transmission time intervals (TTIs) in order to decrease latency. For example, eCC numerology may support TTI lengths of a single symbol or symbol period. Thus, the eCC numerology does not overlap with existing legacy numerologies and would not support multiplexing with the legacy numerologies.

Applicable to both unlicensed and licensed spectrum, the design principles for eCC operations to address include wide bandwidth (e.g., 60 MHz, 80 MHz, 100 MHz, etc.) spectrum sharing, and low latency, which can be achieved using the new numerology with a shortened orthogonal frequency division multiplex (OFDM) symbol duration, shorter TTI, a fast ACK/NAK turn-around, and dynamic switching between downlink and uplink, and different UEs, based on the traffic. Therefore, the systems with eCC operation may adapt based on the needs of the traffic load.

With traffic that can support a larger latency, benefits in efficiency may be achieved through better scheduling decisions, more complex coding or decoding, and the like. However, with small amounts of data that cannot support larger latencies, implementing a very fast response time may sacrifice efficiency, while support the more latency-sensitive data. Thus, a trade-off exists between efficiency and latency.

The frame structure for eCC may be based on a TDD frame structure that includes designated downlink and uplink symbols to enable radio resource management (RRM) measurements, synchronization, channel state information (CSI) feedback, random access channel (RACH), scheduling request (SR), and the like. Such downlink and update designations may be configured by RRC signaling. Dynamic switching between downlink and uplink symbols may also be determined by the dynamic grant. Thus, there would be no need to look-ahead in terms of the number of downlink and uplink subframes for the entire radio frame. This dynamic frame structure would be more dynamic/flexible than the current LTE system.

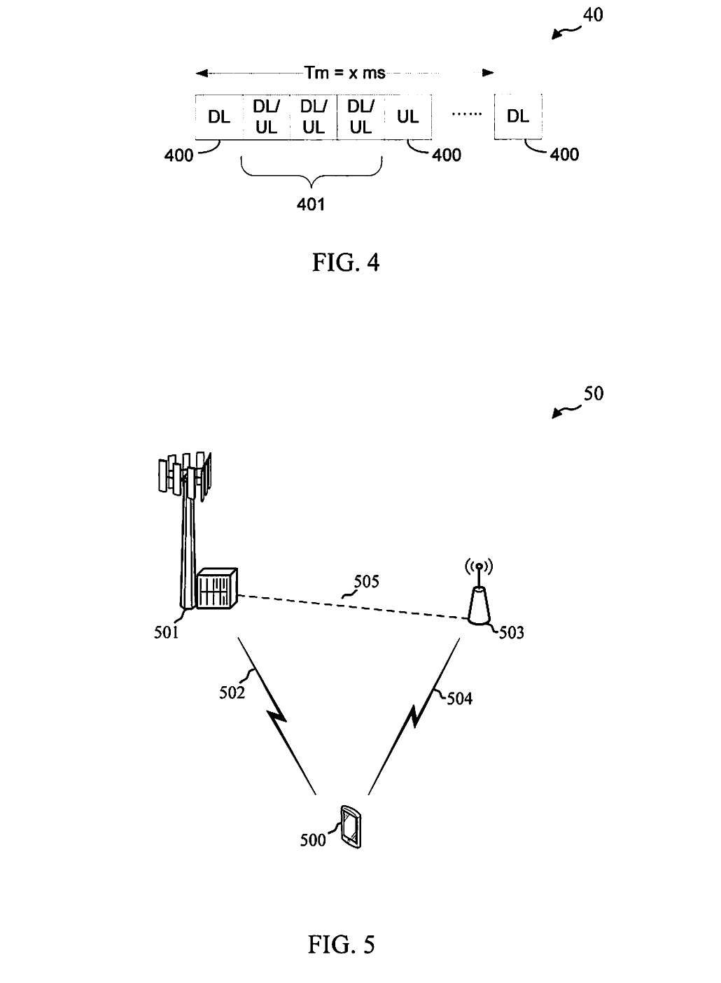

FIG. 4 is a block diagram illustrating eCC transmission stream 40. In TDD transmission, eCC transmission stream 40 is divided into multiple subframes each having an assigned directional allocation, such as uplink or downlink. In eCC transmission stream 40, certain subframes 400 are directionally fixed in either an uplink or downlink configuration, while other subframes 401 are dynamic subframes that may be dynamically changed by the base station to uplink or downlink as the traffic load dictates.

It should be noted that when dynamically switching between downlink and uplink subframes, guard symbols may be defined, such that the first symbol of an uplink subframe immediately following a downlink subframe may be configured as a guard symbol, in which the UE will not expect to transmit uplink data.

eCC operation may be useful when operating in higher carrier frequencies with decreased symbol time. This may also enable very short latencies. The various aspects of the present disclosure provide for discontinuous reception (DRX), semi-persistent scheduling (SPS), and activation/deactivation procedures for an eCC secondary cell (SCell).

In eCC operation, media access control (MAC) issues may arise with SPS operations, DRX operations, and activation/deactivation of the eCC SCell. For SPS operations in eCC, the new eCC numerology would lead to introduction of a new SPS procedure on the eCC SCell. Legacy SPS operates in a time granularity of milliseconds (ms) and the PCell remains operating as in legacy SPS. Thus, with SPS operation in an eCC SCell, there are two SPS procedures on different cells which may either use the same SPS radio network temporary identifier (RNTI) as the PCell or define a new RNTI for the SCell. Regardless of RNTI used, however, the SPS configuration for PCell and SCell are independent.

FIG. 5 is a block diagram illustrating a communication network 50 configured according to one aspect of the present disclosure. UE 500 is served by base stations 501 and 503. Base station 501 provides a PCell 502 over licensed spectrum, while base station 503 provides an eCC SCell 504 over unlicensed spectrum. Base stations 501 and 503 may exchange control and other communications between each other over backhaul 505. When UE 500 enters the coverage areas of base stations 501 and 503, it receives configuration of SPS RNTI for both PCell 502 and eCC SCell 504. Thus, as various SPS grants are provided to UE 500 from base stations 501 and 503, UE 500 will use the SPS RNTI to associate the SPS grant to either PCell 502 or eCC SCell 504.

It should be noted that the SPS RNTI for eCC SCell 504 may be the same SPS RNTI for PCell 502 or it may be a newly defined SPS RNTI specifically for an SCell SPS operation. When the SPS RNTI for eCC SCell 504 is the same as the SPS RNTI for PCell 502, the MAC layer of UE 500 will be able to determine whether the SPS grant is associated with PCell 502 or eCC SCell 504. For example, the SPS RNTI will allow UE 500 to determine when a received signal from one of base stations 501 or 503 is an SPS grant and the grant will be associated either with a PCell or an SCell. Thus, UE 500 will be capable of determining to which carrier the SPS grant applies.

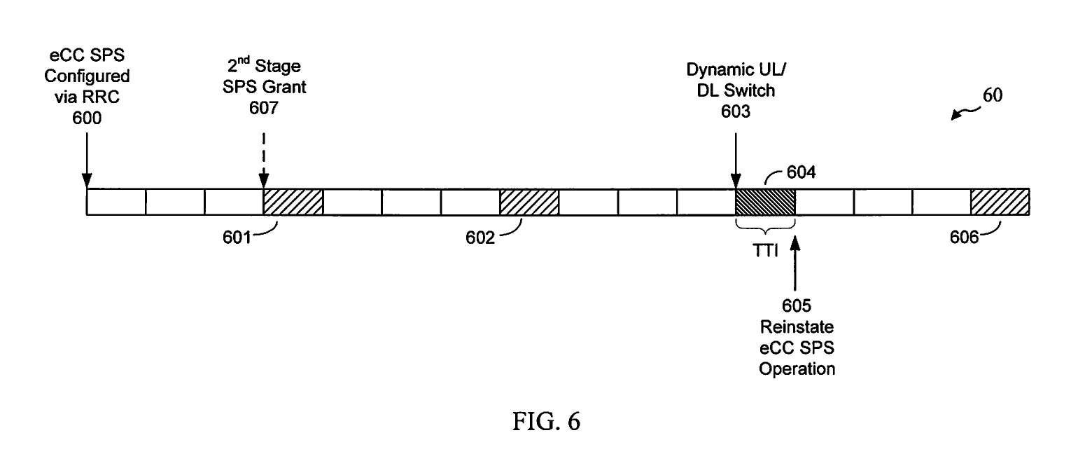

FIG. 6 is a block diagram illustrating the transmission stream between an eCC SCell and a UE configured according to one aspect of the present disclosure. The SPS configuration is signaled in an SPS grant, which is specific to downlink/uplink subframes. Thus, at time 600, an eCC SCell SPS operation is configured using, for example, RRC signaling. At subsequent PDCCH transmissions 601 and 602, the UE will operate according to the eCC SPS configuration provided at time 600. According to aspects of the disclosure, when an eNB dynamically switches a subframe from downlink to uplink or from uplink to downlink at time 603, the SPS instance will be overridden in order to accommodate the new configuration for dynamically switched subframe 604. However, this overriding of the SPS instance does not change the original eCC SPS grant. The eCC SPS configuration will be reinstated at time 605, after a single TTI. The next scheduled PDCCH transmission 606 will again be processed according to the eCC SPS operation configured at time 600.

The SPS grant may also occur in a multi-stage grant process. In the first stage grant, the eNB configures parameter that may not change much over the course of a given SPS instance. For example, in an alternative aspect also illustrated in FIG. 6, the eCC SPS configuration grant at time 600 provided the first stage grant, for elements such as periodicity, modulation and coding scheme (MSC), and the like. When the SPS operation is to be activated or deactivated, the second stage grant assigns the actual resources for the SPS instance and activates or deactivates the SPS procedures. For example, at time 607, the second stage SPS grant actually allocates the resources for the SPS operation and the UE may begin the eCC SPS operation at PDCCH 601.

During current SPS grant procedures, when a UE has transmitted all uplink data in its uplink data buffer, UE will transmit padding or dummy data for the remainder of the SPS allocation. When operating in eCC, a UE, such as UE 500 (FIG. 5), may, instead, transmit and empty buffer indication to base station 503 when the uplink data buffer is empty. UE 500 may send such an indicator at any time on contention-based resources (e.g., on contention-based PUSCI-I and the like). Base station 503 may then de-activate the SPS assignment on eCC SCell 504 upon reception of the indication.

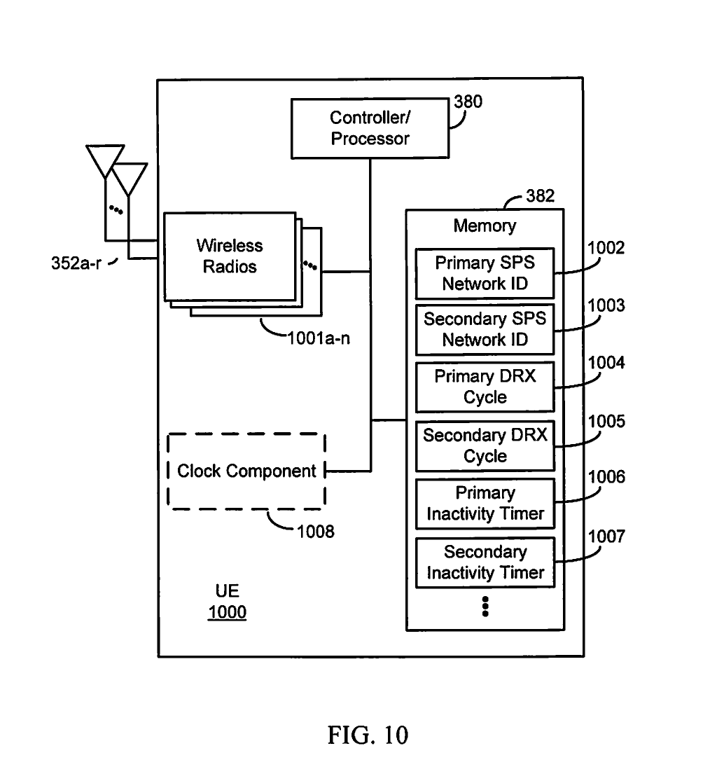

FIG. 7 is a block diagram illustrating example blocks executed to implement one aspect of the present disclosure. The aspect of the present disclosure is described with respect to an example UE as illustrated in FIG. 10. FIG. 10 is a block diagram illustrating a UE 1000 configured according to various aspects of the present disclosure. UE 1000 includes the hardware, components, features, and functionalities as described with respect to UE 115 (FIG. 3). For example, UE 1000 includes controller/processor 380, which operates to execute logic code stored in memory 382 for generating the execution environments that define the features and functionalities of UE 1000. Moreover, controller/processor 380 controls operations of the other hardware and components of UE 1000, such as the components illustrated in FIG. 3. Wireless radios 1001a-n may include components, such as antennas 352a-r, demodulator/modulators 354a-r, MIMO detector 356, and receive processor 358, as well as TX MIMO processor 366, and transmit processor 364, as illustrated in FIG. 3.

At block 700, a UE, such as UE 1000, receives configuration information of a primary SPS network identifier for an SPS operation on a PCell. UE 1000 stores primary SPS network identifier 1002 in memory 382. Primary SPS network identifier 1002 may be an SPS RNTI assigned by a serving base station to UE 1000 for SPS operations that on the PCell configured for UE 1000.

At block 701, the UE, such as UE 1000, also receives a secondary SPS network identifier for SPS operations on an eCC SCell. UE 1000 stores secondary SPS network identifier 1003 in memory 382. The SPS operation on the eCC SCell is separate and independent from the SPS operation configured for the PCell. Secondary SPN network identifier 1003 may include either the same network identifier used for the PCell, such as the PCell SPS RNTI, or it may be an identifier newly defined for operation on an eCC SCell, such as a newly defined eCC SCell SPS RNTI.

At block 702, the UE, such as UE 1000, monitors for primary SPS grants associated with the primary SPS operation on the PCell. The UE monitors for such primary SPS grants using primary SPS network identifier 1002 on signals received through antennas 352a-r and demodulated and decoded using wireless radios 1001a-n. For example, a UE may use the PCell SPS network identifier, primary SPS network identifier 1002, (e.g., an SPS RNTI) to determine whether the signals from the base station are an SPS grant and whether the grant is associated with the PCell.

At block 703, the UE, such as UE 1000, monitors for secondary SPS grants associated with the secondary SPS operation on the eCC SCell. UE 1000 uses secondary SPS network identifier 1003 to determine whether the signals received via antennas 352a-r and demodulated and decoded using wireless radios 1001a-n from the base station are an SPS grant and whether that grant is associated with the eCC SCell.

Because the new eCC numerology does not overlap with the legacy LTE numerology, various aspects of the present disclosure provide for introduction of new discontinuous reception (DRX) procedure on eCC SCells. To accommodate the shorter turn-around times, shorter cycle, and shorter inactivity in the new eCC numerology, the UE is configured to micro-sleep on the eCC during which the UE is allowed to tune away for a shorter period of time.

The basic DRX process in LTE radio resource control (RRC) Connected mode, regardless of retransmission, is controlled by an inactivity timer, and on-duration timer, and the DRX cycle time. The inactivity timer specifies the number of consecutive physical downlink control channel (PDCCH) subframe(s) after successfully decoding a PDCCH indicating an initial uplink or downlink user data transmission for this UE. The on-duration timer specifies the number of consecutive PDCCH subframe(s) at the beginning of a DRX cycle. The DRX cycle specifies the periodic repetition of the on-duration. In the basic DRX process in LTE, during the on-duration period, the UE-side receiver wakes up to monitor the PDCCH. If there is no downlink transmission for this UE, it will turn off its receiver and enter the sleep period instantly after the on-duration timer expires. If the PDCCH is decoded successfully which indicates an initial uplink or downlink data transmission, the UE will enter the inactivity period by starting the inactivity timer, during which the receiver of the UE keeps awake to monitor the PDCCH for possible downlink traffic. If the UE receives a PDCCH indicating a new data transmission before the inactivity timer expires, the inactivity timer will be restarted to prolong the inactivity period to keep the receiver awake. However, if the UE has no downlink data for a certain period of time, the inactivity timer expires and the UE will instantly switch off the receiver. The UE then stays in the sleeping mode until the arrival of the next on-duration. If downlink packets arrive during the sleep period, the base station will store them temporarily and send them to the UE at the next on-duration period. The active time of the DRX process is the time when the UE keeps monitoring the PDCCH, which includes the time when either the on-duration timer or inactivity timer is running.

Additionally, aspects of the present disclosure provide for an SCell-specific DRX configuration that is separate and distinct from the PCell DRX configuration. In legacy operation, the DRX configuration of an SCell follows or is dependent on the DRX configuration of the PCell. The separate SCell-specific DRX configurations run independently on the different cells, including separate DRX timers from the PCell having different designated times or periods from the PCell DRX timers.

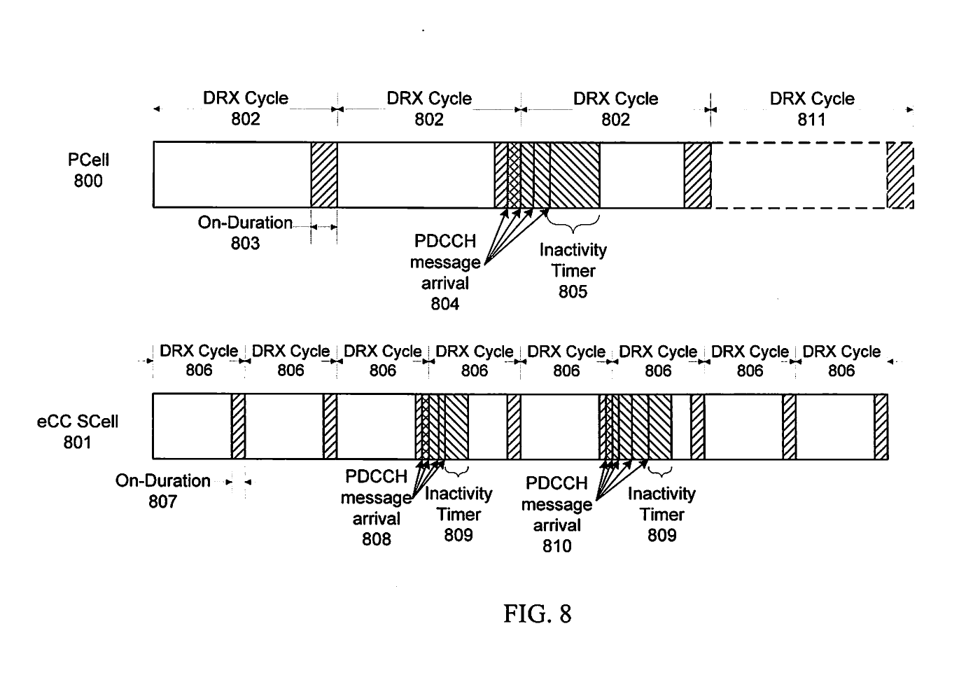

FIG. 8 is a block diagram illustrating PCell 800 and eCC SCell 801 configured according to one aspect of the present disclosure. PCell 800 and eCC SCell 801 are configured for a particular UE. The timers and cycle times for the DRX operation of eCC SCell 801 are separate and independent from the DRX operation of PCell 800. For example, PCell 800 includes a DRX cycle 802 and on-duration period 803. Beginning at the first arrival of PDCCH messages 804 during the on-duration period 803, the UE begins an active time and monitors for, receives, and decodes the PDCCH messages 804. Each time the PDCCH is successfully decoded indicating either downlink or uplink transmissions, the inactivity timer 805 is started or re-started. When inactivity timer 805 expires before receiving any additional PDCCH messages, the UE enters the sleep period.

The DRX operation of eCC SCell 801 has a shorter DRX cycle 806 and shorter on-duration period 807. Similarly, when the first PDCCH message of 808 arrives during on-duration period 807, the UE begins the active time on eCC SCell monitoring for, receiving, and decoding PDCCH messages 808 and 810. Inactivity timer 809 is also a shorter duration that inactivity timer 805 of PCell 800. When inactivity timer 809 expires after receiving the last of PDCCH messages 808 and 810, respectively, the UE enters the shorter sleep periods of eCC SCell 801.

Operations of SCell eCC 801 according to aspects of the present disclosure may also support cross-carrier control signaling, such as layer 2 control signaling. MAC level control elements (CEs) intended for PCell 800 may be transmitted over eCC SCell 801 in order to take advantage of the lower latency in eCC. For example, a DRX command for PCell 800 may be transmitted over eCC SCell 801 in one of PDCCH messages 810. In one example aspect, the MAC CE in PDCCH messages 810 provides a new DRX cycle period 811 for PCell 800. After receiving the new DRX command in PDCCH messages 810, the UE applies new DRX cycle period 811 to PCell 800. Other MAC CE types such as buffer status report, C-RNTI, UE contention resolution identity, power headroom MAC, extended power headroom, MCH scheduling information, and the like may be transmitted over eCC SCell 801 for use on PCell 800.

FIG. 9 is a block diagram illustrating example blocks executed to implement one aspect of the present disclosure. The aspects of the present disclosure identified in FIG. 9 are also described with respect to an example UE, UE 1000, illustrated in FIG. 10. At block 900, DRX operations begin at a UE, such as UE 1000, with both a PCell and an eCC SCell configured for its communications. The blocks illustrated operate in separate and independent tracks by UE 1000.

At block 901, at the beginning of the DRX operation, enters a primary sleep period of a primary DRX cycle associated with the PCell. UE 1000 manages its DRX sleep periods for the primary sleep period using a primary DRX cycle configuration 1004 stored in memory 382. Separately, at block 902, the UE, such as UE 1000, enters a secondary sleep period of a secondary DRX cycle associated with the eCC SCell. UE 1000 also manages the DRX sleep periods for the secondary sleep period using a secondary DRX cycle 1005 configuration stored in memory 382. The secondary sleep period defined by secondary DRX cycle configuration 1005 is different than the primary sleep period defined by primary DRX cycle configuration 1004 and will operate independently from the primary sleep period. For example, the secondary DRX sleep period may be shorter or longer than the primary sleep period.

At block 903, a determination is made whether the primary sleep period has expired. The primary sleep period expires when the next on-duration period is scheduled within the PCell DRX cycle. If the primary sleep period has not yet expired, then UE 1000 remains asleep.

If the primary sleep period has expired, then, at block 905, the primary on-duration period begins in which the UE, such as UE 1000, actively monitors the PCell for a downlink control channel. For example, the receiver within wireless radios 1001a-n of UE 1000 is actively tuned to the PCell and UE 1000 monitors for a PDCCH which may include downlink or indications of uplink transmissions.

At block 904, a similar determination is made whether the secondary sleep period has expired in the eCC SCell. If not, then UE 1000 remains asleep with respect to the eCC SCell.

If the secondary sleep period has expired, then, at block 906, the secondary on-duration period begins in which the UE, such as UE 1000, actively monitors the eCC SCell for a downlink control channel. UE 1000 here tunes the receiver within wireless radios 1001a-n to the eCC SCell to listen for any PDCCH on the eCC SCell that includes downlink or indications of uplink transmissions.

At block 907, a determination is made whether downlink information or indications of uplink transmissions are detected on the PCell. If not, UE 1000 again enters the primary sleep period according to primary DRX cycle configuration 1004.

If downlink information or indications of uplink transmissions are detected, then, at block 909, the primary inactivity timer, such as primary inactivity timer 1006, is started and, at block 911, this information is decoded or the UE prepares for uplink transmissions of its data. Primary inactivity timer 1006 operates under control of controller/processor 380 and may be operated in conjunction with a clock component 1008. Clock component 1008 provides timing and clock functionality using hardware components common to electronic devices.

At block 908, a determination is made with regard to the eCC SCell whether downlink information or indications of uplink transmissions are detected on the eCC SCell. If not, UE 1000 again enters the secondary sleep period according to secondary DRX cycle configuration 1005.

If downlink information or indications of uplink transmissions are detected on the eCC SCell, then, at block 910, the secondary inactivity timer, such as secondary inactivity timer 1007, is started and, at block 911, this information is decoded or UE 1000 prepares for uplink transmissions of its data on the eCC SCell. Secondary inactivity timer 1007 operates under control of controller/processor 380 and may also be operated in conjunction with clock component 1008.

At block 913, a determination is then made whether any additional downlink information or indication of uplink transmission is detected prior to expiration of primary inactivity timer 1006. If such additional information is detected, then, at block 909, primary inactivity timer 1006 is re-started and the additional information is decoded at block 911. If no additional downlink information or indication of uplink transmissions are detected, then, the UE will re-enter the primary sleep mode at block 901 according to primary DRX cycle configuration 1004.

Similarly, at block 914, a determination is made whether any additional downlink information or indication of uplink transmission is detected over the eCC SCell prior to expiration of secondary inactivity timer 1007. If such additional information is detected, then, at block 910, secondary inactivity timer 1007 is re-started and the additional information is decoded at block 912. If no additional downlink information or indication of uplink transmissions are detected, then, UE 1000 will re-enter the secondary sleep mode in the eCC SCell at block 902 according to secondary DRX cycle configuration 1005.

The new eCC numerology also prompts creation of new timers for deactivation of eCC SCells. Because the legacy numerology does not overlap with the new eCC numerology, the legacy SCell timers are not suitable under the new eCC numerology. Accordingly, aspects of the disclosure provide that the legacy SCells may be activated or deactivated from an eCC SCell for a faster deactivation procedure.

Additionally, activation and deactivation of eCC SCells may also occur directly through SCell configuration messages. For example, an eCC SCell may be directly activated via the RRC cell additional message. Thus, the SCell addition message can be used not only to add or configure the eCC SCell for a given UE, but also to activate the SCell without requiring additional MAC control to activate the cell.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules in FIGS. 7 and 9 may comprise processors, electronics devices, hardware devices, electronics components, logical circuits, memories, software codes, firmware codes, etc., or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C) or any combinations thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication, comprising:
receiving, at a user equipment (UE) from a base station, configuration of a primary semi-persistent scheduling (SPS) network identifier for a primary SPS operation on a primary cell (PCell) configured for the UE;
receiving, at the UE from the base station, configuration of a secondary SPS network identifier for a second SPS operation on an enhanced component carrier (eCC) secondary cell (SCell) configured for the UE, wherein the secondary SPS operation is independent of the primary SPS operation;
monitoring, by the UE, for one or more primary SPS grants associated with the primary SPS operation using the primary SPS network identifier; and
monitoring, by the UE, for one or more secondary SPS grants associated with the secondary SPS operation using the secondary SPS network identifier.

2. The method of claim 1, wherein the transmit time interval (TTI) of the eCC secondary cell is shorter than the TTI of the PCell.

3. The method of claim 1, wherein the secondary SPS network identifier comprises the primary SPS network identifier, and wherein the monitoring for one or more secondary SPS grants includes:
identifying the one or more secondary SPS grants as SPS grants based on the primary SPS network identifier; and
identifying the one or more secondary SPS grants as associated with the secondary SPS operation based on the one or more secondary SPS grants being configured for the eCC SCell.

4. The method of claim 1, further comprising:
receiving, at the UE from the base station, an indication associated with one or more subframes of the eCC SCell, wherein the indication dynamically switches a directional allocation of the one or more subframes;
suspending, by the UE, the secondary SPS operation for the one or more subframes.

5. The method of claim 4, further comprising:
reinstating, by the UE the secondary SPS operation after a single transmission time interval (TTI) of the eCC SCell from receiving the indication.

6. The method of claim 1, wherein one or more of the one or more secondary SPS grants comprises a two-stage grant, wherein a first stage grant includes SPS configuration information and a second stage grant includes allocation of resources for an SPS operation.

7. The method of claim 6, further comprising one or more of:
determining an activation state of the one or more of the one or more secondary SPS grants based on the second stage grant; and
determining modification to one or more parameters of an activated SPS grant based on the first stage grant.

8. The method of claim 1, further comprising:
determining, by the UE, that the UE's uplink data buffer is empty;
transmitting, by the UE, an empty buffer indication to the base station in response to the determining; and
receiving, at the UE, a deactivation signal from the base station, wherein the deactivation signal deactivates the secondary SPS operation.

9. The method of claim 8, wherein the transmitting includes:
identifying contention-based uplink resources for transmission by the UE; and
autonomously transmitting, by the UE, the empty buffer indication using the identified contention-based uplink resources.

10. A method of wireless communication, comprising:
entering, by a user equipment (UE), a primary sleep period of a primary discontinuous reception (DRX) cycle associated with a primary cell (PCell) configured for the UE, wherein the primary sleep period triggers the UE to stop monitoring the PCell;
entering, by the UE, a secondary sleep period of a secondary DRX cycle associated with an enhanced component carrier (eCC) secondary cell (SCell) configured for the UE,
wherein the secondary sleep period triggers the UE to stop monitoring the eCC SCell,
wherein the secondary DRX cycle is independent from the primary DRX cycle, and
wherein the secondary sleep period is of a different duration than the primary sleep period; and
actively monitoring, by the UE, a downlink control channel on the PCell after the primary sleep period and on the eCC SCell after the secondary sleep period;
receiving, by the UE, a control element on the downlink control channel of the eCC SCell for operations on the PCell; and
performing operations, by the UE, associated with one or more of: the PCell and one or more SCells based on the control element received on the downlink control channel of the eCC SCell.

11. The method of claim 10, wherein the downlink control channel includes one of: a media access control (MAC) layer channel, or a physical layer channel.

12. An apparatus configured for wireless communication, comprising:
means for receiving, at a user equipment (UE) from a base station, configuration of a primary semi-persistent scheduling (SPS) network identifier for a primary SPS operation on a primary cell (PCell) configured for the UE;
means for receiving, at the UE from the base station, configuration of a secondary SPS network identifier for a second SPS operation on an enhanced component carrier (eCC) secondary cell (SCell) configured for the UE, wherein the secondary SPS operation is independent of the primary SPS operation;
means for monitoring, by the UE, for one or more primary SPS grants associated with the primary SPS operation using the primary SPS network identifier; and
means for monitoring, by the UE, for one or more secondary SPS grants associated with the secondary SPS operation using the secondary SPS network identifier.

13. The apparatus of claim 12, wherein the transmit time interval (TTI) of the eCC secondary cell is shorter than the TTI of the PCell.

14. The apparatus of claim 12, wherein the secondary SPS network identifier comprises the primary SPS network identifier, and wherein the means for monitoring for one or more secondary SPS grants includes:
means for identifying the one or more secondary SPS grants as SPS grants based on the primary SPS network identifier; and
means for identifying the one or more secondary SPS grants as associated with the secondary SAS operation based on the one or more secondary SPS grants being configured for the eCC SCell.

15. The apparatus of claim 12, further comprising:
means for receiving, at the UE from the base station, an indication associated with one or more subframes of the eCC SCell, wherein the indication dynamically switches a directional allocation of the one or more subframes;
means for suspending, by the UE, the secondary SPS operation for the one or more subframes.

16. The apparatus of claim 15, further comprising:
means for reinstating, by the UE the secondary SPS operation after a single transmission time interval (TTI) of the eCC SCell from receiving the indication.

17. The apparatus of claim 12, wherein one or more of the one or more secondary SPS grants comprises a two-stage grant, wherein a first stage grant includes SPS configuration information and a second stage grant includes allocation of resources for an SPS operation.

18. The apparatus of claim 17, further comprising one or more of:
means for determining an activation state of the one or more of the one or more secondary SPS grants based on the second stage grant; and
means for determining modification to one or more parameters of an activated SPS grant based on the first stage grant.

19. The apparatus of claim 12, further comprising:
means for determining, by the UE, that the UE's uplink data buffer is empty;
means for transmitting, by the UE, an empty buffer indication to the base station in response to the means for determining; and
means for receiving, at the UE, a deactivation signal from the base station, wherein the deactivation signal deactivates the secondary SPS operation.

20. The apparatus of claim 19, wherein the means for transmitting includes:
means for identifying contention-based uplink resources for transmission by the UE; and
means for autonomously transmitting, by the UE, the empty buffer indication using the identified contention-based uplink resources.

21. An apparatus configured for wireless communication, the apparatus comprising:
at least one processor; and
a memory coupled to the at least one processor,
wherein the at least one processor is configured:
to receive, at a user equipment (UE) from a base station, configuration of a primary semi-persistent scheduling (SPS) network identifier for a primary SPS operation on a primary cell (PCell) configured for the UE;
to receive, at the UE from the base station, configuration of a secondary SAS network identifier for a second SPS operation on an enhanced component carrier (eCC) secondary cell (SCell) configured for the UE, wherein the secondary SPS operation is independent of the primary SPS operation;
to monitor, by the UE, for one or more primary SPS grants associated with the primary SPS operation using the primary SPS network identifier; and
to monitor, by the UE, for one or more secondary SPS grants associated with the secondary SPS operation using the secondary SPS network identifier.

22. The apparatus of claim 21, wherein the transmit time interval (TTI) of the eCC secondary cell is shorter than the TTI of the PCell.

23. The apparatus of claim 21, wherein the secondary SPS network identifier comprises the primary SPS network identifier, and wherein the program code for causing the computer to monitor for one or more secondary SPS grants includes configuration of the at least one processor:
to identify the one or more secondary SPS grants as SPS grants based on the primary SPS network identifier; and
to identify the one or more secondary SPS grants as associated with the secondary SPS operation based on the one or more secondary SPS grants being configured for the eCC SCell.

24. The apparatus of claim 21, further comprising configuration of the at least one processor:
to receive, at the UE from the base station, an indication associated with one or more subframes of the eCC SCell, wherein the indication dynamically switches a directional allocation of the one or more subframes;
to suspend, by the UE, the secondary SPS operation for the one or more subframes.

25. The apparatus of claim 24, further comprising configuration of the at least one processor to reinstate, by the UE the secondary SPS operation after a single transmission time interval (TTI) of the eCC SCell from receiving the indication.

26. The apparatus of claim 21, wherein one or more of the one or more secondary SPS grants comprises a two-stage grant, wherein a first stage grant includes SPS configuration information and a second stage grant includes allocation of resources for an SPS operation.

27. The apparatus of claim 26, further comprising configuration of the at least one processor to one or more of:
determine an activation state of the one or more of the one or more secondary SPS grants based on the second stage grant; and
determine modification to one or more parameters of an activated SPS grant based on the first stage grant.

28. The apparatus of claim 21, further comprising configuration of the at least one processor:
to determine, by the UE, that the UE's uplink data buffer is empty;
to transmit, by the UE, an empty buffer indication to the base station in response to the determination that the uplink data buffer is empty; and
to receive, at the UE, a deactivation signal from the base station, wherein the deactivation signal deactivates the secondary SPS operation.

29. The apparatus of claim 28, wherein the configuration of the at least one processor to transmit includes configuration of the at least one processor:
to identify contention-based uplink resources for transmission by the UE; and
to autonomously transmit, by the UE, the empty buffer indication using the identified contention-based uplink resources.
